(19) United States
(12) Patent Application Publication
(10) Pub. No.: US 2020/0126021 A1
(43) Pub. Date: Apr. 23, 2020

(54) System and method for distributing sports officiating opportunities

(71) Applicant: Ron Doak, Houston, TX (US)

(72) Inventor: Ron Doak, Houston, TX (US)

(21) Appl. No.: 16/350,231

(22) Filed: Oct. 18, 2018

(51) Int. Cl. G06Q 10/06; A63B 71/06; G06Q 20/10; G06Q 50/10

(52) U.S. Cl. CPC G06Q 10/063112; G06Q 50/10; G06Q 20/102; A63B 71/0616

(57) ABSTRACT

A system for providing an interface that allows access to a database system used to provide entrepreneurial officiating opportunities to adults and students throughout the United States and Canada. The disclosed system is a means and method and has the functionality that allows a user to access at least fourteen different sports officiating opportunities including the direct contacts for each sport by state and province, rules of each sport, equipment required for each sport, organization fees for each sport, and approximate fees paid for each sport. The sports that this system may integrate may comprise all aspects of each sport and include: football, baseball, basketball, volleyball, soccer, softball, hockey, tennis, lacrosse, rugby, field hockey, swimming, rugby, et.al.

### FIELD OF THE DISCLOSURE

The present disclosure generally relates to a database system for providing individuals a means and method of obtaining all necessary information, including contacting the relevant governing body(s), to register to be an official for at least fourteen different sports. More particularly, it provides the specific information for all required fees and equipment; as well as specific details with which to contact, apply, be trained and become an entrepreneurial, independent sports official. Still more particularly, the database system and associated methods of the present disclosure provide all needed information that may allow students, and others, to become a paid independent entrepreneurial sports official in all fifty States and ten Canadian Provinces.

### BACKGROUND

The prior art that was discovered was not directly associated with any sports as an investigative tool to apply and become an independent entrepreneurial sports official in every U.S. state and Canada. The databases and other sports systems appear to be systems for maintaining a database of sports officials and the assigning, paying and schedule of contests, games and matches. U.S. Pat. No. 7,231,379, refers to recognition and response specifying voice interpretation. U.S. Pat. No. 7,742,946 B2 refers to a means of managing sales of advertisements. U.S. Pat. No. 6,405,188 B1 describes determining probabilities. U.S. Pat. No. 6,745,177 provides a means of retrieving from multiple data bases from data base searches; the content of the present disclosure provides an improvement in that it details the method, as well as the means, to obtain desired information in an organized and specific manner. U.S. Pat. No. 8,036,493 B1 describes a method for correcting orientation of patent figures. U.S. Pat. No. 7,424,438 refers to a means of providing employment services whereas the subject of the present disclosure is directed towards providing self-employed sports official, entrepreneurial opportunities. U.S. Pat. No. 8,660,967 provides a means to seek posted job information and applications from job searches. U.S. Pat. No. 7,836,060 pertains in general to information retrieval, and more specifically to multi-way nested searching and retrieval of information. Even more specifically, it pertains to identifying words that have varied meaning within a matrix. U.S. Pat. No. 7,870,117 provides a means of random searches to provide a requested outcome by means of extraction/matching from text. U.S. Pat. No. 6,457,009B1 describes a method of querying multiple databases to create a response from each that would correspond to the use of a generic form to obtain a response from a master meta database of databases utilizing. 457

The subject matter of the present disclosure provides an improvement over prior art in that the disclosed subject matter of the description herein comprises a means and method and has the functionality not previously found in a patent search as that of obtaining information that is not nor has not been advertised or posted for job information or application. Most of the existing art provides a means to do abstract searching for pre-determined unknowns, whereas the subject matter of the present disclosure provides specific electronically sourced information from known input(s) sources and provides details for all the information needed to become an entrepreneur and independent sports official.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure provide a novel, useful, and nonobvious system that provides individuals throughout the United States and Canada a means for locating, evaluating, and applying to become a self-employed, entrepreneurial paid sports official. One benefit of the system of the present disclosure is that it is Intra and Internet based and available twenty four hours a day, three hundred and sixty-five days a year. It brings every state in the United States, plus Canada, and twelve different sports into instantaneous review for application and information on sports officiating opportunities for adults seeking a paid entrepreneurial avocation and part-time job opportunities for students to earn funds while attending school. It provides an option from having to work in a fast food or transportation industry whereby part-time employment now appears to be very limited in employee selection in time and hours available to work.

There is a critical shortage of sports officials for both men and women in the United States and Canada. As the population increases, the need for additional sports officials will grow. In the meantime, many students throughout the United States and Canada are leaving their schools of higher learning with huge student debt. The estimated student debt today is over 1.5 Trillion Dollars. The Canadian student debt today is over 28 Billion. Average student debt per student in the United States is over $35,000.00 and the Canadian average student debt per student is over $25,000.00. These figures are unconscionable.

Many students attempt to reduce the amount of funds to be borrowed by working part-time. Most part-time jobs only pay minimum wage and the hours are not as flexible as many require. The systems and methods of the present disclosure may provide many, if not most, with an option with which to defray most, if not all, current need to incur debt to earn a degree or gain advanced educational instruction.

Students are not the only potential recipients of the provided information the systems and methods of the present disclosure may provide. Adults seeking a life-long avocation supplementing their current income may find the disclosed subject matter helpful in becoming an entrepreneur and self-employed independent contractor in any and all sports they choose to consider.

A user may choose which country they are interested in obtaining specific information on becoming a sports official. Once chosen, the user may setup their USER ID and provide necessary information to establish a personal, private account. Once registered, the user may choose which state or province they are interested in obtaining information. Once the location is chosen, the user may be presented with 14 or more sports that require officiating. The user may then, if interested, be directed to the cost of obtaining all information needed for that sport in that state or province. Once the user has used a secure on-line payment, all the information for each sport chosen, including individual application fees, rules, typical pay for each, usual time of the event, and a means of direct contact with the assigning authority in each area would be made available on-line for download and return review with each sign-on.

This systems and methods of the present disclosure provide a means and method and may have the functionality to effectively and efficiently obtain needed information, through a series of pre-determined hierarchy to provide a user the information needed to start the user's own entrepreneurial sports officiating endeavors. The invention is executed in a programmed computer that has a hierarchically process that has decisional flow, control and operations that must be navigated as part of the processing. This patent solves the specific problem of matching students and adults that seek to reduce student debt attending higher educational courses and/or adults that seek entrepreneurial opportunities as a life-long avocation. The disclosed subject matter is particularly applicable to transactional processing as applied to instances wherein a user may be given options from which to choose a course of action that provides a pre-determined outcome that will enable the user to create the user's own entrepreneurial independent business using sports officiating as the vehicle. A user may be able to build an individual personal library of the necessary and required information to identify, create and establish a user the option of an independent, entrepreneurial sports officiating business.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a flowchart illustrating an exemplary dataflow within an exemplary sports database management system, according to one or more aspects of the present disclosure.

### DETAILED DESCRIPTION

The present disclosure is directed to sports database management systems and associated methods of use for providing (e.g., allocating and selling) sports officiating opportunities to a user.

Aspects of the present disclosure provide a system for facilitating the ability of a user to obtain the information needed to become an independent entrepreneur working as a sports official in at least fourteen different individual and group sports. In some aspects, the system may comprise a computer processor and a memory device configured internally and/or externally that is in communication with the computer processor, wherein the memory device is configured to store a plurality of instructions that, when executed, perform one or more steps, including: providing one or more selectable options to the user in response to an input received from user so the user can select desired outcomes based on specific selected units and providing the user with a means for reading, copying, downloading, and saving in a preselected memory cache, be it internally or externally. In some additional aspects, the one or more selectable options may further include an option to access sports data from the United States and/or Canada. In response to receiving a user selection of at least one country, an option to search for specific information pertaining to one or more individual sports, including the similarities and differences amongst various sports, is presented to the user. In still some additional aspects, the plurality of instructions stored within the memory device, when executed, may further perform the step of determining whether the user is in the United States or Canada. In yet some additional aspects, the one or more selectable options further include an option to access select and access one or more individual states and/or provinces. In still some further aspects, the plurality of instructions stored within the memory device may, when executed by the computer processor, in response to receiving a user selection of the option to access at least one state and/or province may further perform the steps of: searching a sports database, retrieving sports information for searching the sports database, cross referencing one or more matches found in a user database and a programming database, and generating at least one message for the user, wherein the at least one message comprises a list of sports officiating opportunities for the user. In yet some further aspects, the plurality of instructions stored within the memory device may, when executed by the computer processor, further perform the steps of: reading a user request from a user database, retrieving information for at least one sport, searching the programming database for matching sports information comprised of programming information and demographic information of the states and provinces, searching the sports database for matching sports information, cross referencing the matches found in the databases and generating a message for the user, wherein the message comprises a list of sports officiating opportunities for the user.

In some aspects, the sports database management systems of the present disclosure may further comprise at least one computer readable medium with program instructions tangibly stored therein, wherein the instructions, when executed, perform one or more steps, comprising: providing an interface application, displayed on an electronic device, said interface application having selectable options including at least one option to access message data, at least one option to access user data, at least one option to access programming data, and at least one option to place an order. In some additional nonlimiting embodiments, in response to receiving a user selection, via an electronic input device, of the option to access message data, the program instructions stored with the at least one computer readable medium, when executed, may further perform the step of searching a message database, wherein the message database stores messages generated by the management system; in response to receiving a user selection, via the electronic input device, of the option to access user data, accepting a user identifier, searching the user database for matching user information, and displaying the matching user information, wherein the matching user information includes user contact information, desired areas for the user, desired sport(s), demographic information of target groups for the user, type of programming, desired rates for the desired sport(s), and desired ancillary information; in response to receiving a user selection, via the electronic input device, of the option to access programming data, searching the programming database based at least partially on the type of programming; retrieving matching programming information from the programming database, wherein the matching programming information includes at least one available sport; and displaying the at least one available sport and one or more corresponding parameters; in response to receiving a user selection, via the electronic input device, of the option to place an order, placing an order for at least one sport for the user, approving a request to place an order, in response to said approval, adding the at least one sport from the at least one user database for insertion into the programming information, and in response to said adding, billing the user for the at least one ordered sport. In some additional aspects. The at least one computer readable medium may further comprising instructions wherein the selectable options further include an option to access at least one of: sport(s) rules and mechanics for each sport; an option to access required equipment for each sport; an option to access the listed fee to join the governing organization of each sport; an option to access posted fees paid for each individual sport; and an option to access direct contact information for each sport; wherein the at least one computer readable medium further comprises instructions that, when executed, in response to receiving a user selection of the option to access sports data, cause one or more steps to be performed, including: searching a sports database, retrieving promotions information for searching said sports database for matching sports information, cross referencing one or more matches found in user database and the programming database and generating a message for the user, wherein the at least one message comprises a list of sports officiating opportunities for the user. In still some additional aspects, the at least one computer readable medium may further comprise instructions for accessing a billing database that is configured to maintain an accounting system in a program storage device for charging user for one or more selected sport(s). In yet some additional aspects, the at least one computer readable medium may further comprise instructions for receiving a request to bill a user for one or more selected sport(s), retrieving a billing record for the user, and updating the billing record to debit the user for the one or more selected sport(s). In still some further aspects, the at least one computer readable medium may further comprise instructions for requesting payment responsive to a determination that the user is not approved for credit, receiving said payment, and wherein the updating of the billing record is responsive to receiving said payment.

In some aspects, a method for providing a sport(s) database management system for selling and allocating sports officiating opportunities to a user, such as a potential entrepreneurial sports official, is disclosed, wherein the method may comprise: providing an interface application, displayed on an electronic device, the interface application having one or more selectable options, including at least one option to access message data, at least one option to access user data, at least one option to access programming data, and at least one option to place an order; receiving, via at least one electronic input device, a selection from the at least one user to access message data; searching at least one message database, wherein the at least one message database is configured to store one or more messages generated by the sports database management system; receiving, via the at least one electronic input device, a selection from the at least one user to access user data; accepting a user identifier; searching at least one user database for matching user information; displaying the matching user information, wherein the matching user information comprises at least one of: user contact information, desired areas for the user, desired time slots, demographic information of target groups for the user, one or more desired sport types to officiate, and rates for the desired sport information; receiving, via the at least one electronic input device, a selection from the at least one user to access programming data; searching at least one programming database based at least partially on the type of programming; retrieving matching programming information from the at least one programming database, wherein the matching programming information comprises at least one available sports officiating opportunity; displaying the at least one available sports officiating opportunity and one or more corresponding parameters; receiving, via the at least one electronic input device, a selection from the at least one user to place at least one order; placing at least one order for at least one sport for the at least one user; approving a request to place the at least one order; adding at least one sport from at least one user database for insertion into the programming information; billing the at least one user for the at least one sport; accessing at least one billing database that is configured to maintain an accounting system in at least one program storage device for charging the at least one user for requested sports data; receiving at least one request to bill the at least one user for one or more selected sports; retrieving a billing record for the at least one user; and updating the billing record to debit the at least one user for the one or more selected sports.

In some aspects, the sports database management systems in accordance with the present disclosure may further comprises at least one computer generated means to facilitate the ability of a user to electronically retrieve information via at least one of: printing, saving, and copying the information.

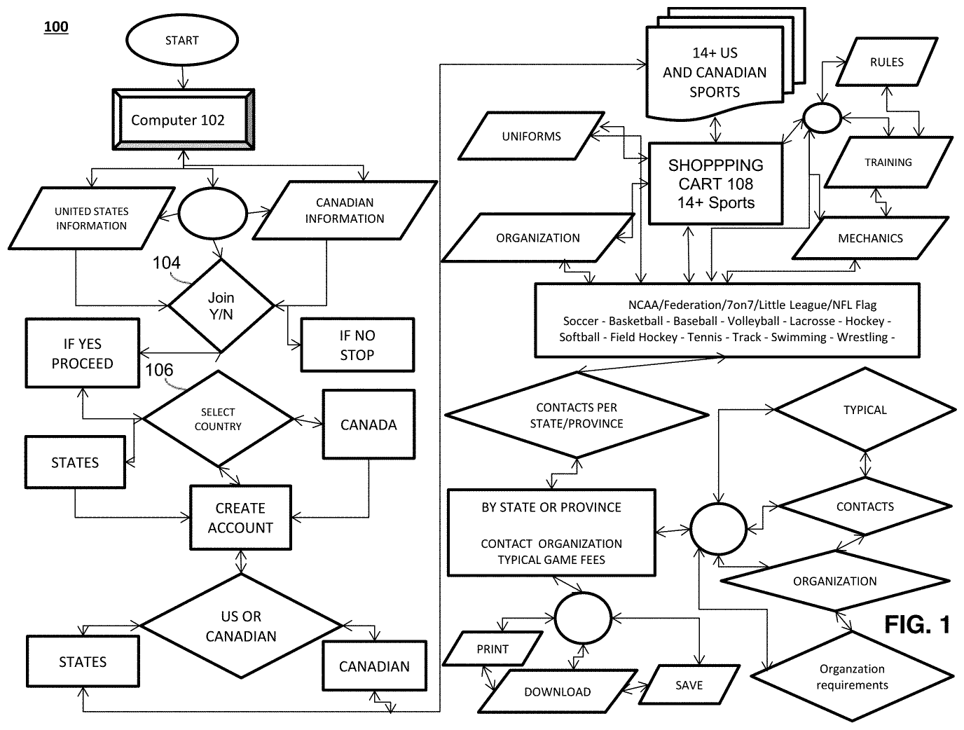

Referring now to FIG. 1, a flowchart illustrating an exemplary dataflow 100 within an exemplary sports database management system, according to one or more aspects of the present disclosure, is shown.

A user may utilize at least one electronic device, such as computer 102, in order to be provided with a sports database management system in accordance with the present disclosure. Computer 102 may comprise a processing unit and network access and may function to create a hierarchal relationship system whereby the user may select either the United States or Canada to determine which country the user is interested in querying about sports officiating. Once a selection is made, the user may be directed to either the United States or Canada. The user may then be provided with the option 104 to join or not join the program's next query stop or go command. If the user chooses to join, the user may proceed to the next query 106 of selecting the state or province the user is interested in exploring. The user may then be provided with the ability to create an account by country which may then open a shopping cart 108 that may provide the 50 U.S. states and 10 Canadian provinces and may list 14 sports within each state and province. The necessary particulars of each sport may also be provided, such as the rules, training, mechanics, uniforms, and organization name. The user may be given the specific contact for each sport for each of the 50 U.S. states and 10 Canadian provinces. The user may further be shown an approximate fee schedule for each sport by each of the 50 U.S. states and 10 Canadian provinces. Finally, the user may be shown the outcome of each search as requested, such as via printing, downloading, and/or saving it.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., utilization with other sports and/or occupations other than those mentioned herein). As will be appreciated by those skilled in the relevant art(s) after reading the description herein, certain features from different aspects of the systems and methods of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

1. A system for facilitating the ability of at least one user to obtain information to become an independent entrepreneur working as a sports official, comprising:
at least one computer processor; and
at least one memory device in communication with the at least one processor, wherein the at least one memory device is configured to store plurality of instructions that, when executed, perform one or more steps, including:
providing selected one or more selectable options to the at least one user in response to at least one input received from the at least one user so and;
providing the at least one user with a means for reading, copying, downloading, and saving in a preselected memory cache.

2. The system of claim 1, wherein the one or more selectable options include an option to select sports data for at least one country.

3. The system of claim 2, wherein in response to receiving a selection of at least one country, an option to search for specific information pertaining to one or more sports is presented to the at least one user.

4. The system of claim 3, wherein the at least one memory device is configured to store a plurality of instructions that, when executed by the at least one computer processor, further perform the step of: determining in what country the at least one user is located.

5. The system of claim 4, wherein the one or more selectable options further include an option to select one or more individual states or provinces within a country.

6. The system of claim 5, wherein the at least one memory device is configured to store a plurality of instructions that, when executed by the at least one computer processor, in response to receiving a selection from the at least one user of at least one state or province, further perform the steps of: searching at least one sports database, retrieving sports information for searching the at least one sports database, cross referencing one or more matches found in at least one user database and at least one programming database, and generating at least one message for the at least one user, wherein the at least one message comprises a list of sports officiating opportunities for the at least one user.

7. The system of claim 5, wherein the at least one memory device is configured to store a plurality of instructions that, when executed by the at least one computer processor, further perform the steps of: reading at least one user request from at least one user database, retrieving information for at least one sport, searching at least one programming database for matching sports information comprised of programming information and demographic information, searching at least one sports database for matching sports information, cross referencing matches found in databases and generating at least one message for the at least one user, wherein the at least one message comprises a list of sports officiating opportunities for the at least one user.

8. The system of claim 6, wherein the system further comprises at least one computer readable medium with program instructions tangibly stored therein, wherein the instructions, when executed, perform one or more steps, comprising:
providing an interface application, displayed on an electronic device, said interface application having selectable options including at least one option to access message data, at least one option to access user data, at least one option to access programming data, and at least one option to place an order;
in response to receiving a selection from the at least one user, via at least one electronic input device, to access message data, searching at least one message database, wherein the at least one message database stores messages generated by at least one management system;
in response to receiving a selection from the at least one user, via the at least one electronic input device, to access user data, accepting a user identifier, searching the at least one user database for matching user information, and displaying the matching user information, wherein the matching user information includes user contact information, desired areas for the user, desired sport(s), demographic information of target groups for the user, type of programming, desired rates for the desired sport(s), and desired ancillary information;
in response to receiving a selection from the at least one user, via the at least one electronic input device, to access programming data, searching the at least one programming database based at least partially on the type of programming; retrieving matching programming information from the at least one programming database, wherein the matching programming information includes at least one available sport, and displaying the at least one available sport and one or more corresponding parameters;
in response to receiving a selection from the at least one user, via the at least one electronic input device, to place an order, placing an order for at least one sport for the at least one user, approving a request to place an order, adding the at least one sport from the at least one user database for insertion into the programming information, billing the at least one user for the at least one ordered sport.

9. The at least one computer readable medium of claim 8, further comprising instructions wherein the selectable options further include at least one option to access at least one of: rules and mechanics for each sport;
at least one option to access required equipment for each sport;
at least one option to access the listed fee to join the governing organization of each sport;
at least one option to access posted fees paid for each sport; and
at least one option to access direct contact information for each sport;
wherein the at least one computer readable medium further comprises instructions that, when executed, in response to receiving at least one selection from the at least one user to access sports data, cause one or more steps to be performed, including: searching a sports database, retrieving promotions information for searching said sports database for matching sports information, cross referencing the one or more matches found in the at least one user database and the at least one programming database and generating the at least one message for the at least one user, wherein the at least one message comprises a list of sports officiating opportunities for the at least one user.

10. The at least one computer readable medium of claim 6, further comprising instructions for accessing at least one billing database that is configured to maintains an accounting system in at least one program storage device for charging the at least one user for one or more selected sports.

11. The at least one computer readable medium of claim 6, further comprising instructions for receiving at least one request to bill the at least one user for one or more selected sports, retrieving a billing record for the at least one user, and updating the billing record to debit the at least one user for the one or more selected sports.

12. The at least one computer readable medium of claim 11, further comprising instructions for requesting payment responsive to a determination that the at least one user is not approved for credit, receiving said payment, and wherein the updating of the billing record is responsive to receiving said payment.

13. A method for providing a sports database management system for selling and allocating sports officiating opportunities to at least one user, the method comprising:
providing an interface application, displayed on an electronic device, the interface application having one or more selectable options, including at least one option to access message data, at least one option to access user data, at least one option to access programming data, and at least one option to place an order.

14. The method of claim 13, further comprising:
receiving, via at least one electronic input device, a selection from the at least one user to access message data; and
searching at least one message database, wherein the at least one message database is configured to store one or more messages generated by the sports database management system.

15. The method of claim 13, further comprising:
receiving, via the at least one electronic input device, a selection from the at least one user to access user data;
accepting a user identifier;
searching at least one user database for matching user information; and
displaying the matching user information, wherein the matching user information comprises at least one of: user contact information, desired areas for the user, desired time slots, demographic information of target groups for the user, one or more desired sport types to officiate, and rates for the desired sport information.

16. The method of claim 13, further comprising:
receiving, via the at least one electronic input device, a selection from the at least one user to access programming data;
searching at least one programming database based at least partially on the type of programming;
retrieving matching programming information from the at least one programming database, wherein the matching programming information comprises at least one available sports officiating opportunity; and
displaying the at least one available sports officiating opportunity and one or more corresponding parameters.

17. The method of claim 1, further comprising:
receiving, via the at least one electronic input device, a selection from the at least one user to place at least one order;
placing at least one order for at least one sport for the at least one user:
approving a request to place the at least one order;
adding at least one sport from at least one user database for insertion into the programming information; and
billing the at least one user for the at least one sport.

18. The method of claim 13, further comprising:
accessing at least one billing database that is configured to maintain an accounting system in at least one program storage device for charging the at least one user for requested sports data.

19. The method of claim 13, further comprising:
receiving at least one request to bill the at least one user for one or more selected sports;
retrieving a billing record for the at least one user; and
updating the billing record to debit the at least one user for the one or more selected sports.

20. The system of claim 1, wherein the system further comprises at least one computer generated means to facilitate the ability of the at least one user to electronically retrieve information via at least one of: printing, saving, and copying the information.

21. (canceled)
